(19) United States
(12) Patent Application Publication
(10) Pub. No.: US 2012/0185481 A1
(43) Pub. Date: Jul. 19, 2012

(54) Method and Apparatus for Executing a Recommendation

(75) Inventors: Jonas Björk, Stockholm (SE); Mattias Lidström, Stockholm (SE); Simon Moritz, Stockholm (SE); Joakim Söderberg, Solna (SE)

(73) Assignee: TELEFONAKTIEBOLAGET LM ERICSSON (PUBL), Stockholm (SE)

(21) Appl. No.: 13/496,900

(22) PCT Filed: Sep. 21, 2009
(86) PCT No.: PCT/SE09/51047

§ 371 Date: Mar. 19, 2012

(51) Int. Cl. G06F 17/30

(52) U.S. Cl. 707/737; 707/E17.089

(57) ABSTRACT

A method, apparatus and system for generating recommendations of items to users. Ratings of items made by users are collected (1:1). User behaviour information is also collected (1:2). Then correlations in ratings are obtained (1:3) and similarities in user behaviour amongst the users are obtained (1:4). Thereafter, an item for recommendation to a user is identified (1:5), based on both the correlations in ratings and on the similarities in user behaviour amongst the users and the item is recommended to the user (1:6).

### TECHNICAL FIELD

The present invention relates generally to a method for executing recommendation on the basis of an improved recommendation scheme, and an apparatus for executing such a recommendation.

### BACKGROUND

In today's world of ever increasing amounts of information, it gets more and more important to be able to find, or rather be presented with, information that may be of interest to a person. The information can pertain to many different things in relation to different services. For example, a person may like to receive recommendations of different web-sites that he or she might find interesting, recommendations of movies, foods, games, music, CDs, DVDs, or other objects or products and/or services. In this description, the term “item” is used to represent any object, information source, product or service that can be recommended to a user.

Persons are also often given the opportunity to provide their ratings on different items that they have purchased, consumed or otherwise experienced in some manner. This is often done with the purpose to be able to recommend the rated item or items to other persons who might find this recommendation useful or valuable.

Different methods for making such recommendations, often referred to as filtering, have been employed. The two most common methods are known as collaborative filtering (CF) and content-based filtering.

Collaborative approaches find and recommend items to an individual user, which items have been rated highly by other users who have a pattern of ratings similar to that of the user receiving the recommendation. Collaborative filtering systems can produce recommendations by computing the similarity between different user's preferences for a specific item. There are mainly two types of collaborative filtering methods: item based filtering methods and user based filtering methods. Item based recommendations are looking at similarities of the preferences an item has got from different users compared to other items and consequently, user based recommendations are looking at the similarities between users with respect to their characteristics and preferences.

The content-based filtering methods suggest items based on keywords and information about the users or items themselves.

Hybrid recommender systems have also been proposed, which combine collaborative filtering methods and content-based filtering methods. These hybrid systems can have four different architectures, implemented separately and combining their respective recommendations, incorporating some content-based characteristics into a collaborative filtering algorithm, and also incorporating some collaborative filtering characteristics into a content-based filtering algorithm or a unified model which incorporates both content-based and collaborative filtering algorithms.

However, there are two generally well-known problems associated with traditionally collaborative filtering, the so-called “First-Rater” problem and the “Cold-Start” problem.

The First-Rater problem refers to new items in the system, which items have not yet received any ratings from any user. The system is therefore unable to generate semantic interconnections to these items and therefore, they cannot be recommended to any user unless they eventually become rated in due course.

The Cold-Start problem refers to new users in the system, which users have not submitted any ratings as yet. Without any information about the user and/or the user's ratings, the system is not able to predict the user's preferences and is not able to generate recommendations until enough items have been rated by that user.

It could also be the case that two users in the same dataset have not made enough ratings in order to get an overlap, and hence the users have no correlation in their preferences and their respective item ratings will not have an impact on each other's recommendations. This is a common problem when the datasets with items and users are large, since the fraction of items that each user has rated will be very small.

Merely as an example, assume that an online bookstore or an online CD/DVD store has 100000 titles or items. An average user would probably buy well under 0.1% of those titles/items, i.e. well under a 100 titles/items over a long period of time. This implies that it takes a long period of time as well as a great number of users, each making several purchases, before it is possible to make or find correlations between users and/or items. Consequently, it is very difficult to make any item recommendations for a particular user due to the lack of basis.

It is also known to introduce the demographics of users and the metadata of items into the recommender system in order to handle these problems. A user's demographics relate to information about the user, such as his/her home location, age, gender, hair colour and so on. An item's metadata is data or information of the item. For example, if the item is a book, its metadata may comprise the name of the author, the genre of the book, the main character(s) in the book and so on. The above demographics and metadata are thus generally considered to be static information, which does not change dynamically.

However, this approach of introducing the demographics of users and the metadata of items into the recommender system has several problems. Since the information is very static and does not change over time, no new information is added into the system. Also, it has very little relevance to the preferences of the user or users. For example, two persons, who live close to each other, are about the same age and the same gender, do not necessarily have the same preferences. Consequently, this approach is not very useful in view of the First-Rater problem and the Cold-Start problem.

### SUMMARY

It is an object of the invention to address at least some of the problems outlined above. In particular, it is an object to identify an item or items for recommendation to a user. These objects and others may be obtained by providing a method and an apparatus according to the independent claims attached below.

According to one aspect, a method is defined for generating recommendations of items to users. In this method, ratings of items made by users are collected. User behaviour information is also collected. Then correlations in ratings and similarities in user behaviour amongst the users are obtained. An item is then identified for recommendation to a user, based on both the correlations in ratings and on the similarities in user behaviour amongst the users, and the item is recommended to the user. By this solution, introducing user behaviour when identifying an item for recommendation to a user, reflecting the current behaviour of the users, a greater overlap between the users can be achieved, which makes it possible to compute more accurate correlations between the users. Furthermore, this solution may alleviate at least some of the effects of the First-Rater problem and the Cold-Start problem. By obtaining similarities in user behaviour amongst the users, items are identified that may be of interest to other users having similar behaviour.

According to another aspect, an apparatus is provided, which is adapted to identify items for recommendation to a user and recommending said items to said user. The apparatus comprises a collecting unit adapted to collect ratings of items, which ratings are made by users and the apparatus is adapted for collecting user behaviour information. The apparatus also comprises an obtaining unit adapted to obtain correlations in ratings and adapted for obtaining similarities in user behaviour amongst the users, and an identifying unit adapted to identify an item for recommendation to a user, based on both the computed correlations in ratings and on the computed similarities in user behaviour. Further, the apparatus comprises a recommending unit adapted to recommend the item to the user.

Different embodiments are possible in the method and apparatus above.

In one embodiment, the similarities in user behaviour amongst the users are computed by clustering similar users together using machine learning techniques such as K-means clustering methods, support vector machine methods, Latent Semantic Analysis (LSA) or Probabilistic Latent Semantic analysis (PLSA). By organising or clustering users having similar usage behaviour into clusters, users having similar behaviour can be identified.

In other possible embodiments, feedback from a user or users is collected, the feedback relating to previously recommended items.

In yet another embodiment, exploit and explore factors are determined depending on the feedback and on the number of ratings performed by the user, wherein the exploit factor is related to correlation in ratings and the explore factor is related to similarities in user behaviour.

In another possible embodiment, a positive feedback, indicating that said user has consumed a previously recommended item, when the explore factor is greater than the exploit factor, will give more weight to the explore factor, whereas a negative feedback, indicating that said user has not consumed a previously recommended item, will give less weight to the explore factor. Similarly, when the exploit factor is greater than the explore factor, a positive feedback will give more weight to the exploit factor, whereas a negative feedback will give less weight to the exploit factor.

Further, in another embodiment, weights may be adjusted in accordance to the exploit and explore factors, wherein the exploit factor is given more weight the more ratings a user has given and the explore factor is given more weight the less ratings a user has given, and wherein the identifying of an item for recommendation to a user, is further based on said exploit and explore factors and said weights.

In yet further embodiments, ratings are predicted with the adjusted weights and recommendations are produced by ranking the predicted values. Thereby, it is possible to train the procedure and the apparatus to be more or less exploitative and/or explorative depending on the feedback and the number of ratings a user has given.

In yet possible embodiments of the method and the apparatus, the user behaviour information may be collected from Charging Data Records, Dynamic User Data Records and/or Location Data Records.

According to yet another aspect, a system for finding an item or items for recommendation to a user is provided. The system comprises a first database for storing data, related to ratings of items and/or users, and a second database for storing dynamic user data, related to user behaviour information. The system also comprises an apparatus adapted to retrieve ratings of items and/or users from the first database and computing correlations in ratings, and an apparatus adapted to retrieve user behaviour information from the second database and to compute similarities in user behaviour amongst the users. The system further comprises an apparatus adapted to retrieve computed similarities in user behaviour amongst users, to retrieve computed correlations in ratings, and adapted to identify an item or items for recommendation to a user based on both the computed correlations in ratings and the computed similarities in user behaviour.

In an embodiment, the system also comprises a Service Delivery Node for providing a service to the user and for requesting recommendations of items to the user.

Further possible features and benefits of the invention will be explained in the detailed description below.

### BRIEF DESCRIPTION OF THE DRAWINGS

The invention will now be described in more detail by means of preferred embodiments and with reference to the accompanying drawings, in which:

FIG. 1 is a flowchart illustrating an exemplary procedure for executing a recommendation to a user.

FIG. 2 is a flowchart of the method according to another embodiment.

FIG. 3 is a signalling diagram illustrating an exemplary procedure for executing a recommendation to a user.

FIG. 4 is a block diagram illustrating an embodiment of an apparatus for executing a recommendation to a user.

FIG. 5 is a block diagram illustrating a system for executing a recommendation to a user.

### DETAILED DESCRIPTION

Briefly described, a method, an apparatus and a system are provided to identify an item to be recommended to a user according to an improved recommendation scheme. As stated earlier, the term “item” is used to represent any object, product or service that can be recommended to a user.

A typical recommendation system, according to the prior art, collects ratings of items made by users and obtains correlations in ratings in order to identify an item that might possibly be of interest to a user.

In this solution, the method, the apparatus and the system can be used to identify an item to be recommended to a user, wherein the identifying of the item is performed by collecting user behaviour information, obtaining similarities in user behaviour amongst the users in addition to collecting ratings of items made by users and obtaining correlations in ratings. Then the identifying of an item for recommendation to a user is based on both the correlations in ratings and on the similarities in user behaviour. Once an item has been identified as potentially being of interest to a user, the item is recommended to the user.

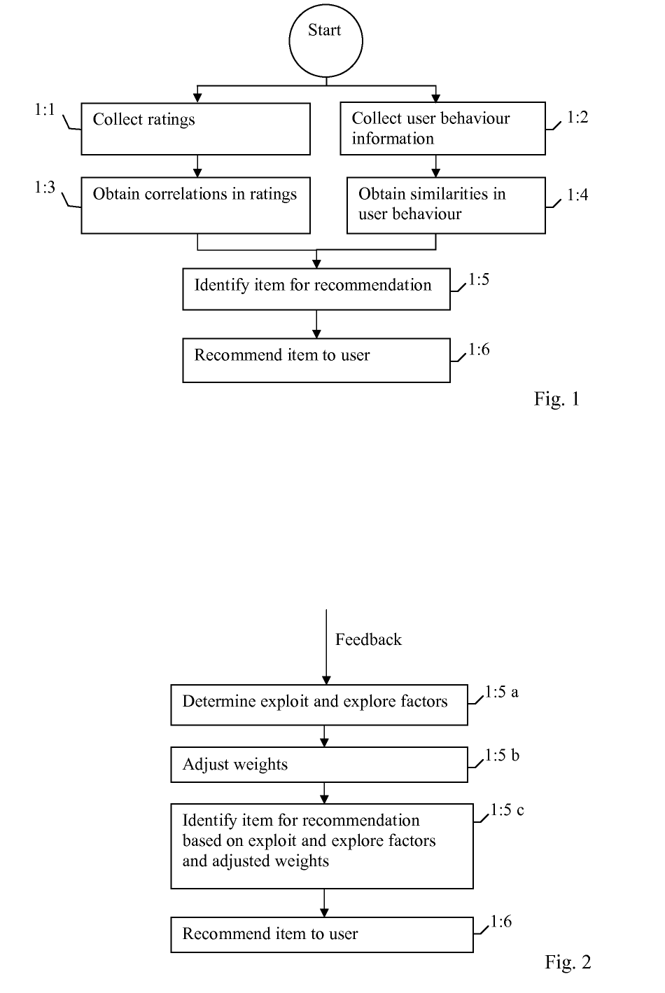

An example of how the method can be performed will now be described with reference to the flowchart in FIG. 1. In this example, ratings of items made by users are collected in a first step 1:1. Also user behaviour information is collected in a second step 1:2. Then correlations in ratings are obtained in a third step 1:3 and similarities in user behaviour amongst the users are also obtained in a fourth step 1:4. Thereafter, an item for recommendation to a user is identified in a fifth step 1:5, based on both the correlations in ratings and on the similarities in user behaviour and the item is recommended in a sixth step 1:6 to said user.

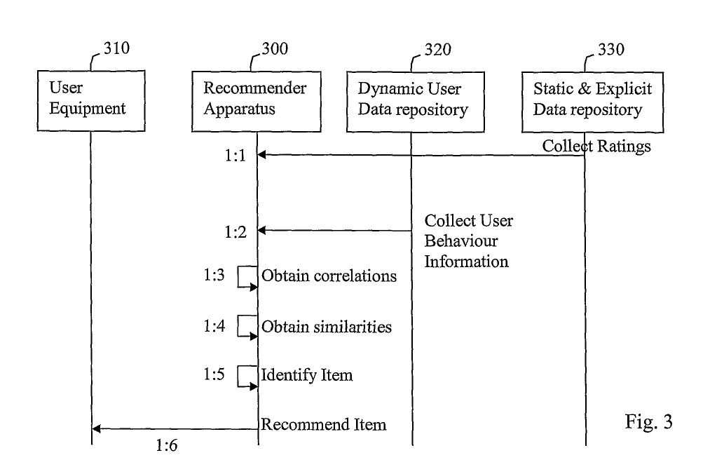

FIG. 3 is a signalling diagram which may be used when implementing the method shown in FIG. 1, wherein steps 1:1-1:6 are illustrated as a signalling flow involving the following logical nodes: Recommender Apparatus 300, User Equipment 310, Dynamic User Data repository 320 and Static and Explicit Data repository 330. It shall be noted that these nodes are merely logical nodes and the method is not limited to being implemented in nodes such as those illustrated in FIG. 3.

FIG. 3 illustrates that ratings of items made by users are collected in a first step 1:1 from the Static and Explicit Data repository 330. In the second step 1:2, user behaviour information is collected from the Dynamic User Data repository 320. Thereafter, correlations in ratings are obtained in a third step 1:3 and similarities in user behaviour amongst the users are also obtained in a fourth step 1:4. In a fifth step 1:5, an item for recommendation to a user is identified based on both the correlations in ratings and on the similarities in user behaviour. Thereafter, the identified item is recommended in a sixth step 1:6 to said user.

By introducing user behaviour when executing the step 1:5 of identifying an item for recommendation to a user, reflecting the current behaviour of the users, a greater overlap between the users can be achieved, which makes it possible to compute more accurate correlations between the users.

The user behaviour may comprise similar behaviour in calling other users. Certain users may make many relatively short calls; some users may send relatively many text messages. Certain users may make relatively long calls, whereas other users may send relatively few text messages. There may be similarities in the way some users utilise the Internet and/or mobile Internet. Other exemplary similarities may be travelling behaviours, the way some users travel, the frequency with which some users travel, destinations that some users travel to (location data), and so forth. Users sharing similar behaviour, and maybe also static data, would possibly also share similar taste.

In order to make a recommendation by combining different types of data, there should be some relation between the types of data. For example, location data may be a good candidate for recommending stores and/or restaurants to users, but may not be a good candidate for recommending books.

Preferably, the correlations in ratings and the similarities in user behaviour are stored in order to increase online performance. This information may be stored, e.g., in a cache memory. In such a case, the third step 1:3 of obtaining correlations in ratings and the fourth step 1:4 of obtaining similarities in user behaviour amongst the users may preferably comprise retrieving this information from the cache, in addition to calculating the correlations in ratings and the similarities in user behaviour from the information that is collected in steps 1:1 and 1:2.

In one embodiment, the similarities in user behaviour amongst the users are computed by clustering similar users together using machine learning techniques such as K-means clustering methods, support vector machine methods, Latent Semantic Analysis (LSA) or Probabilistic Latent Semantic Analysis (PLSA). These are techniques that are known per se in the prior art and other suitable techniques may be used.

A clustering method is a network data mining tool. “Data mining” is a general term, which in this description refers to a concept for processing or handling a large quantity of data which can be used to find similarities in user behaviour. Such data mining can be used to cluster users according to certain behaviour so that two users having similar usage behaviour could be said to belong to the same cluster. The cluster may then be classified to have certain behaviour and from that it is plausible to conclude that a user belonging to a certain cluster will have certain characteristics.

The correlations in ratings (or users) can be computed using an existing correlation method, e.g. Pearson or Double Weighted Correlation.

According to further possible embodiments, feedback from a user or plural users is collected, wherein the feedback relates to previously recommended items.

The feedback can be implicit, for example the user purchases or in some way consumes the recommended item or refrains from purchasing or consuming the recommended item. The feedback can also be explicit, for example when the user rates the recommended item.

The feedback may preferably be stored in a Static and Explicit Data Repository for storing data, relating to ratings of items and/or users. The feedback may be collected together with the collecting of ratings of items made by users that are collected in the first step 1:1, from the same data repository.

A more detailed example of how step 1:5 in FIG. 1 can be executed according to another possible embodiment, will now be described with reference to the flowchart in FIG. 2.

The operation in step 1:5, identifying an item for recommendation to a user, may thus comprise a further step 1:5a of determining “exploit” and “explore” factors depending on the feedback and on the number of ratings performed by the user, wherein the exploit factor is related to correlation in ratings and the explore factor is related to similarities in user behaviour.

In the case of a new user, who has not yet rated any items or only rated very few items, the explore factor will preferably be high as the method will make more use of the similarities in user behaviour amongst users than of the correlations in ratings. As the user rates more and more items, the exploit factor will become higher as the method will make more and more use of the correlations in ratings.

Further, if a user is relatively new in the system or within the service and has not rated any items or just a few items so that the explore factor is high, a positive feedback, indicating that the user has consumed a previously recommended item, will give more weight to the explore factor and a negative feedback, indicating that the user has not consumed a previously recommended item, will give less weight to the explore factor.

Assume that an item has been recommended to a user and that the recommendation is more based on similarities in user behaviour rather than correlations in ratings. This means that the method is inclined towards being explorative. A positive feedback indicates a successful recommendation and may increase the explore-ability of the method. Correspondingly, a negative feedback indicates an unsuccessful recommendation and may reduce the explore-ability of the method.

Similarly, assume that an item has been recommended to a user and that the recommendation is more based on correlations in ratings rather than similarities in user behaviour. This means that the method is inclined towards being exploitative. A positive feedback indicates a successful recommendation and may increase the exploit-ability of the method. Correspondingly, a negative feedback indicates an unsuccessful recommendation and may reduce the exploit-ability of the method.

Further, weights may be adjusted, in an additional step 1:5b, in accordance to the exploit and explore factors, wherein the exploit factor is given more weight the more ratings a user has given and the explore factor is given more weight the less ratings a user has given, and wherein the identifying of an item for recommendation to a user, is further based on the exploit and explore factors and the weights, in step 1:5c.

By introducing the above-described exploit and explore factors and weights that may be adjusted in accordance to the exploit and explore factors, it is possible to control or adjust the proceedings with respect to the influence of the correlations in ratings and the similarities in user behaviour amongst the users. For example, if a user has rated a limited amount of items so that there may merely exist a little overlap or even no overlap at all in ratings, then it might not be possible to identify any items for recommendation to that particular user. In such a case, the similarities in user behaviour amongst the users may be given more influence by giving the explore factor more weight. If a user has rated a relatively large amount of items, it is more likely that an overlap in ratings can be found and hence other items can be identified for recommendation to that particular user. In such a case, correlations in ratings may be given more influence by giving the exploit factor more weight.

It shall be noted that a user may have rated relatively many items, which may give more weight to the exploit factor, and at the same time, the feedback indicates that items that have been recommended to the user based on the explore factor have been given positive feedback or that items that have been recommended to the user based on the exploit factor have been given negative feedback, which will give more weight to the explore factor. Both factors are considered in the method.

Merely as an example, assume that the method has been running for a while and that at a specific time the method identifies an item for recommendations to a user based 70% on the correlations in ratings, A, and 30% on similarities in user behaviour, B. This means that the method is inclined towards being exploitative. Assume that a negative feedback is received, indicating that the item was not consumed or rated negatively by the user who received the recommendation. In such a case, the exploit and explore factors may, for example, be adjusted so that the next item that is identified for recommendation to the user is identified based 60% on the correlations in ratings, A, and 40% on similarities in user behaviour, B. Assume instead that a positive feedback is received, indicating that the item was consumed or rated positively by the user who received the recommendation. In such a case, the exploit and explore factors may, for example, be adjusted so that the next item that is identified for recommendation to the user is identified based 80% on the correlations in ratings, A, and 20% on similarities in user behaviour, B. By constantly adjusting the exploit and explore factors, the method will adjust to the changes in the system or service, such as the introduction of new items or users.

In the following, the similarities in user behaviour are denoted Fₛᵢₘ and the correlations in ratings are denoted F_{corr}. Further, the weight for the correlations in ratings is denoted a, and the weight for the similarities in user behaviour is denoted b. Then the adjustment factors between the correlations and the similarities may be expressed as:

$$Two \text{-} dimensional similarities = \frac{a * {F}_{corr} + b * {F}_{sim}}{a + b} ,$$

where a increases the influence from the correlations in ratings and b increases the influence from the similarities in user behaviour amongst the users.

The model above for calculating the similarities can be trained by adjusting the values of a and b to match a user given rating value. These values can then be adjusted or changed depending on the feedback, where the feedback relates to previously recommended items. This can be used to decide if the method for generating recommendations of items to users should be inclined towards being explorative or exploitative.

A traditional recommender system, as known in the prior art, would recommend according to the exploit factor only.

Further, ratings may be predicted with the adjusted weights.

Predicting ratings means that the method predicts how a particular user would rate specific items among possible items which have been found by the correlation in ratings and/or the similarities in user behaviour. Each specific item among the possible items is thus given a predicted rating for that particular user.

According to another possible embodiment, the prediction of ratings may be performed using a nearest neighbourhood algorithm.

Further, the recommendations may be produced by ranking the predicted values.

The items found are ranked in accordance with the predicted ratings. The items having the highest predicted ratings are then eligible for recommendation to that particular user.

User behaviour information may be collected from Charging Data Records, Dynamic User Data and/or Location Data.

The collecting of user behaviour information may comprise collecting charging data, which reflects a user's use of his/her terminal, for example his/her mobile station, laptop or other any terminal the user may employ to communicate, to surf the Internet, to purchase or consume items, and so on. Charging data may be collected from any type of node or database comprising charging data. Also data warehouse systems and other types of consumer information management systems are examples of suitable and/or possible nodes or databases from which user behaviour information may be collected.

Another example of user behaviour is, as stated before, dynamic user data such as location data. Such information may be collected from nodes and/or databases comprising location data information and from nodes and/or databases comprising call detail records (CDR).

The procedure described above may be triggered or initiated when a user wishes to make use of a service of any kind, or logs on to a service provider. The user himself/herself may request suggested recommendation or the recommendations may be generated automatically, when the procedure above is employed. Typically, a service is associated to a service node or the like. Some examples of such a service node are an application server, MSDP (Mobile Service Delivery Platform) and IAP (IPTV Application Platform). Such a node could also be responsible for requesting recommendations of items to a user.

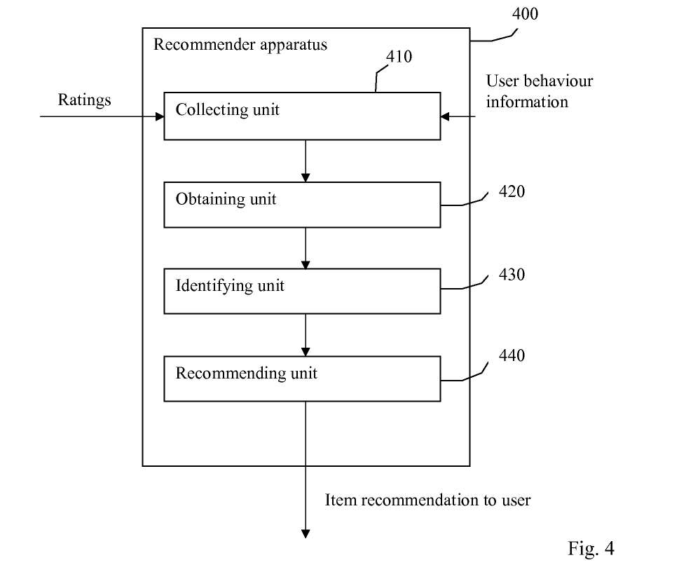

A recommender apparatus 400, which is adapted to identify items for recommendation to a user and recommending said items to said user, will now be described in more detail with reference to FIG. 4.

FIG. 4 is a block diagram illustrating an embodiment of such an apparatus. It should be noted that FIG. 4 merely illustrates various functional units in the recommender apparatus 400 in a logical sense. However, the skilled person is free to implement these functions in practice using any suitable software and hardware means. Thus, the invention is generally not limited to the shown structures of the recommender apparatus 400 and functional units.

The apparatus 400 is thus adapted to identify items for recommendation to a user and recommending said items to said user, and comprises a collecting unit 410 adapted to collect ratings of items made by users and adapted to collect user behaviour information. It further comprises an obtaining unit 420 adapted to obtain correlations in ratings and adapted to obtain similarities in user behaviour amongst the users. The apparatus 400 also comprises an identifying unit 430 adapted to identify an item for recommendation to a user, based on both the computed correlations in ratings and on the computed similarities in user behaviour, and a recommending unit 440 adapted to recommend the item to the user.

In FIG. 4, the collecting unit 410 is illustrated as being one unit within the recommendation apparatus 400. The collecting unit may in practice be divided into two separate collecting units, one unit for collecting ratings of items and one unit for collecting user behaviour information. Likewise, the obtaining unit 420 is illustrated as one unit but may in the same manner comprise two separate obtaining units. Further, these units may be implemented as parts of the recommendation apparatus. However, they may alternatively be implemented in a distributed manner so that they are separate units or incorporated into other nodes or apparatuses.

The identifying unit 430 and the recommending unit 440 may in the same manner be implemented in one apparatus or incorporated into other nodes or apparatuses.

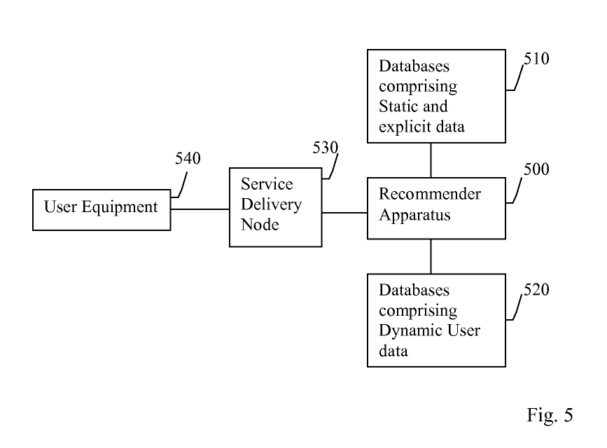

A system is also provided that is configured for identifying an item or items for recommendation to a user. An exemplary embodiment of such a system is shown in FIG. 5.

The system in FIG. 5 comprises a first database 510 for storing data, related to ratings of items and/or users. The system also comprises a second database 520 for storing dynamic user data, related to user behaviour information. Further, the system comprises a recommender apparatus 500, which can be configured as the recommender apparatus 400 in FIG. 4. The recommender apparatus 500 is adapted to retrieve user ratings of items and/or users from said first database 510 and computing correlations in ratings. In addition, the apparatus 500 is adapted to retrieve user behaviour information from said second database 520 and to compute similarities in user behaviour amongst the users. Further, the apparatus 500 is adapted to retrieve computed similarities in user behaviour amongst users, to retrieve computed correlations in ratings, and adapted to identify an item or items for recommendation to a user of a user equipment 540 based on both the computed correlations in ratings and the computed similarities in user behaviour.

The system may further comprise a Service Deliver Node (SDN) 530 for providing a service to the user 540.

As described above, a service may be associated to a Service Delivery Node or the like. Some examples of such a service node are an application server, MSDP (Mobile Service Delivery Platform) and IAP (IPTV Application Platform). Such a node could also be responsible for requesting recommendations of items to a user. A Service Delivery Node 530 is typically logically arranged between the user 540 and the Recommender Apparatus 500.

Again, it should be noted that FIG. 5 merely illustrates various functional units or nodes in the system and the recommendation apparatus 500 in a logical sense. However, the skilled person is free to implement these functions and apparatus in practice using any suitable software and hardware means. Thus, the invention is generally not limited to the shown structures of the system and recommender apparatus 500.

While the invention has been described with reference to specific exemplary embodiments, the description is generally only intended to illustrate the inventive concept and should not be taken as limiting the scope of the invention. The present invention is defined by the appended claims.

1-12. (canceled)

13. An apparatus configured to identify items for recommendation to a user and recommend said items to said user, said apparatus comprising:
a collecting unit configured to collect ratings of items made by users and to collect user behavior information;
an obtaining unit configured to obtain correlations in ratings by computing the correlations and to obtain similarities in user behavior amongst the users by computing the similarities, by clustering similar users together using machine learning techniques;
an identifying unit configured to identify an item for recommendation to a user, based on both the computed correlations in ratings and on the computed similarities in user behavior; and
a recommending unit configured to recommend said item to said user.

14. The apparatus of claim 13, wherein the apparatus is further configured to compute the similarities in user behavior amongst the users by clustering similar users together using one or more machine learning techniques, including at least one of: K-means clustering methods, support vector machine methods, Latent Semantic Analysis (LSA), and Probabilistic Latent Semantic Analysis (PLSA).

15. The apparatus of claim 13, wherein the apparatus is further configured to retrieve feedback from users, the feedback relating to previously recommended items.

16. The apparatus of claim 15, wherein the apparatus is further configured to determine exploit and explore factors depending on the feedback and on the number of ratings performed by a user, wherein the exploit factor is related to a correlation in ratings and the explore factor is related to similarities in user behavior, in order to identify an item for recommendation to the user.

17. The apparatus of claim 16, wherein the apparatus is further configured to give more weight to the explore factor when a positive feedback, indicating that the user has consumed a previously recommended item, is received and to give less weight to the explore factor when a negative feedback, indicating that the user has not consumed a previously recommended item, is received.

18. The apparatus of claim 16, wherein the apparatus is further configured to adjust weights as a function of the exploit and explore factors, wherein the exploit factor is given more weight the more ratings the user has given and the explore factor is given more weight the less ratings the user has given.

19. The apparatus of claim 18, wherein the apparatus is further configured to predict items, for recommendation to the user, with the adjusted weights.

20. The apparatus of claim 19, wherein the apparatus is further configured to predict items for recommendation to the user using a nearest neighborhood algorithm.

21. The apparatus of claim 19, wherein the apparatus is further configured to produce recommendations by ranking the predicted values.

22. The apparatus of claim 13, wherein the apparatus is further configured to collect the user behavior information from at least one of: Charging Data Records, Dynamic User Data Records, and Location Data Records.

23. A system configured to find an item or items for recommendation to a user, said system comprising:
a first database storing data, related to ratings of at least one of items and users;
a second database storing dynamic user data, related to user behavior information;
an apparatus configured to retrieve ratings of items or users from said first database and compute correlations in ratings;
an apparatus configured to retrieve user behavior information from said second database and to compute similarities in user behavior amongst the users by clustering similar users together using machine learning techniques; and
an apparatus configured to retrieve computed similarities in user behavior amongst users, to retrieve computed correlations in ratings, and to identify an item or items for recommendation to a user based on both the computed correlations in ratings and the computed similarities in user behavior.

24. The system of claim 23, further comprising Service Delivery Node for providing a service to the user and for requesting recommendations of items to the user.
